(19) United States
(12) Patent Application Publication
(10) Pub. No.: US 2015/0369611 A1
(43) Pub. Date: Dec. 24, 2015

(54) AUTOMATED MALL CONCIERGE

(71) Applicant: Tracy Ogishi, Redwood City, CA (US)

(72) Inventor: Tracy Ogishi, Redwood City, CA (US)

(21) Appl. No.: 14/309,335

(22) Filed: Jun. 19, 2014

(51) Int. Cl. G01C 21/20; G06Q 10/10; G06F 17/30

(52) U.S. Cl. CPC G01C 21/206; G06F 17/3053; G06Q 10/1095

(57) ABSTRACT

A system and method of providing an automated mall concierge are disclosed. In some embodiments, a plurality of stores for a user to visit at a shopping mall is determined based on at least one experience preference indicator, a route for the user to use in visiting the plurality of stores is determined based on crowd level data, the crowd level data indicating at least one crowd level associated with visiting the plurality of stores, and the route is caused to be displayed to the user on a computing device. In some embodiments, a request is received from the user for an appointment at an appointment-capable store. The request can indicate a time of the appointment. The appointment for the indicated time can be scheduled with the appointment-capable store. The determination of the plurality of stores and the determination of the route can be based on the scheduled appointment.

### TECHNICAL FIELD

The present application relates generally to the technical field of data processing, and, in various embodiments, to systems and methods of providing an automated mall concierge.

### BACKGROUND

Current shopping mall directories are static. As a result, there is a lack of useful information provided to shoppers regarding how to maximize their shopping mall experience, which may lead to aggravation on the part of the shoppers and, consequently, lost business to the stores at the shopping mall.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with some embodiments;

FIG. 2 is a block diagram depicting various components of a network-based publisher, in accordance with some embodiments;

FIG. 3 is a block diagram depicting various tables that may be maintained within a database, in accordance with some embodiments;

FIG. 4 is a block diagram illustrating a mall concierge system, in accordance with some embodiments;

FIG. 5 illustrates a shopping mall environment in which a mall concierge system can be employed, in accordance with some embodiments;

FIG. 6 illustrates a route being displayed to a user, in accordance with some embodiments;

FIG. 7 illustrates a notification being provided, in accordance with some embodiments;

FIG. 8 is a flowchart illustrating a method, in accordance with some embodiments;

FIG. 9 is a flowchart illustrating a method, in accordance with some embodiments;

FIG. 10 is a flowchart illustrating a method, in accordance with some embodiments;

FIG. 11 is a flowchart illustrating a method, in accordance with some embodiments;

FIG. 12 is a flowchart illustrating a method, in accordance with some embodiments;

FIG. 13 is a flowchart illustrating a method, in accordance with some embodiments;

FIG. 14 is a block diagram illustrating a mobile device, in accordance with some example embodiments; and

FIG. 15 shows a diagrammatic representation of a machine in the example form of a computer system within which a set of instructions may be executed to cause the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure provides systems and methods of providing an automated mall concierge. The automated mall concierge can provide recommendations of stores to visit, recommended routes for a user to use in visiting stores, an appointment-scheduling service, and notifications for meeting back up with shopping companions, as well as a variety of other features. The features of the automated mall concierge can be provided on a mall computing device (e.g., a mall directory or kiosk) or on a user's mobile device (e.g., via a mobile application or via a web browser accessing a website). In some embodiments, the features of the automated mall concierge can initially be provided on a mall computing device, and then sent (e.g., pushed) to the user's mobile device, thereby enabling the user to use the features of the mall concierge system after the user has walked away from and can no longer view the mall computing device.

In some embodiments, when a user enters a shopping mall, a mall concierge system can identify the user, either explicitly or implicitly. The mall concierge system can then review profile information of the user. The profile information can be built on explicit information and/or implicit information. Examples of explicit information include, but are not limited to, favorite brands and/or stores explicitly identified by a user. Examples of implicit information include, but are not limited to, a history of purchases by the user, and a history of what stores the user has visited. Other implicit information can be based on physically identifiable information, including, but not limited to, gender of a user, height of a user, colors or patterns of clothing or accessories being worn by a user, and length of hair of a user. This physically identifiable information can be obtained via the use of one or more cameras and visual recognition software. The profile information, along with context information (e.g., time/day, number/type of companions, user's entry point or starting location, current promotional events), can be used to build a personalized map that optimizes the user's route through the shopping mall. The mall concierge system can additionally or alternatively use explicit user input (e.g., a user's selection or identification of particular stores or particular categories of stores) to build the personalized map. The mall concierge system can determine crowd levels at key points throughout the shopping mall in order to help optimize the user's route. Crowd levels can be determined based on a determination of certain factors, including, but not limited to, current body density in stores, length of lines for dressing rooms at stores, length of lines for checkout at stores, and body density in the interconnecting walkways between the stores. This crowd level data can be used along with predictive modeling in order to estimate the amount of time it will take the user to walk to a store and to estimate the amount of time the user will spend in a store. The mall concierge system can use historical traffic patterns (or other crowd level data) of people in the shopping mall in order to generate one or more predictive models to use in estimating the amount of time for a user to travel to a store and/or the amount of time for a user will spend in a store. The mall concierge system can use the estimated amounts of time to create a personalized route for the user in order to make the most efficient use of the user's time. The mall concierge system can also incorporate data regarding appointments of the user into the determination of the route, in order to make sure that the route leaves enough time for the user to make his or her appointments. The mall concierge can also determine additional stores to add to the route based on a determination that these additional stores are relevant to the user (e.g., a new store has brand affinity with other stores that the user likes, a store has new collections/arrivals, a store is having a sales event, a store has a specialty event such as a book signing or a trunk show).

In some embodiments, the mall concierge system can determine potential appointments for the user's experience at the shopping mall. For example, the mall concierge system can determine and recommend to the user potential appointments for lunch at a restaurant for the user and his family at the shopping mall, a nail appointment for the user and her daughter at a beauty salon at the shopping mall, a stylist session for the user at a department store beauty department, and/or a visit for the user's child with Santa Claus at a Christmas section of the shopping mall. Many other types of appointments are also within the scope of the present disclosure. Using online booking/reservation tools and/or application programming interfaces (APIs), the mall concierge system can automatically find the best possible timeslots for appointments and schedule the appointments for the user. In some embodiments, in response to detecting the presence of the user or that the user is within a predetermined distance of a mall computing device, the mall concierge system can offer a proposed agenda on the mall computing device, including proposed appointments. The user can then confirm/book the appointments, edit them, or decline them. The mall concierge system can then process the user's input regarding the appointments accordingly. In some embodiments, the mall concierge system can offer appointments for stores to a user based on information regarding stores with which similar users (e.g., other users with profile information determined to exceed a predetermined level of similarity with the profile information of the current user) have visited, made purchases, or otherwise shown interest. The mall concierge system can also alert a user to special offers or deals for stores based on profile information of the user that indicates an interest in those stores or a corresponding category of stores.

Although the present disclosure discusses embodiments of features of a mall concierge system being employed within the context of a shopping mall, it is contemplated that the features disclosed herein can be implemented in other environments as well. In some embodiments, the features of the present disclosure can be implemented in any environment having multiple independent vendors and/or exhibits. Examples of environments other than shopping malls in which the features of the present disclosure can be employed include, but are not limited to, theme parks, amusement parks, conventions, music festivals, film festivals, art festivals, food courts, and museums.

In some embodiments, a plurality of stores for a user to visit at a shopping mall are determined based on at least one experience preference indicator, a route for the user to use in visiting the plurality of stores is determined based on crowd level data, the crowd level data indicating at least one crowd level associated with visiting the plurality of stores, and the route is caused to be displayed to the user on a computing device. The experience preference indicator(s) can indicate an experience preference associated with the user. In some embodiments, the route is caused to be displayed as part of a map displayed to the user.

In some embodiments, the at least one crowd level comprises at least one of corresponding crowd levels for each one of the plurality of stores and corresponding crowd levels for different walking paths between the plurality of stores. In some embodiments, the corresponding crowd levels for each one of the plurality of stores and corresponding crowd levels for different walking paths between the plurality of stores are determined based on at least one of current crowd levels and a predictive model using historical information of previous crowd levels.

In some embodiments, determining the plurality of stores comprises prompting the user to submit the at least one experience preference indicator, and receiving the at least one experience preference indicator from the user. In some embodiments, the at least one experience preference indicator comprises at least one of a store identification, a store category, a product identification, a brand identification, a product category, and a service category.

In some embodiments, determining the plurality of stores comprises determining an identification of the user, accessing profile information of the user based on the identification of the user, and determining the at least one experience preference indicator based on the accessed profile information. In some embodiments, the profile information comprises at least one of a history of stores the user has visited, a history of products the user has purchased, and a history of services the user has purchased.

In some embodiments, the determination of the plurality of stores is further based on context information, the context information comprising at least one of a time of day for the user visiting the plurality of stores, a day of the week for the user visiting the plurality of stores, an amount of desired or available shopping time, at least one scheduled appointment for the user, a crowd level corresponding to the user visiting the plurality of stores, a number of companions of the user, a type of companion of the user, and a promotion being offered by at least one of the plurality of stores. In some embodiments, the determination of the route is based on context information, the context information comprising at least one of a time of day for the user visiting the plurality of stores, a day of the week for the user visiting the plurality of stores, at least one scheduled appointment for the user, a crowd level corresponding to the user visiting the plurality of stores, a number of companions of the user, a type of companion of the user, and a promotion being offered by at least one of the plurality of stores.

In some embodiments, a recommendation for an appointment for a user at an appointment-capable store is determined, the recommendation for the appointment is caused to be displayed to the user on the computing device, a request for the appointment is received from the user, the request indicating a time of the appointment, and the appointment for the indicated time is scheduled with the appointment-capable store. In some embodiments, the determination of the plurality of stores and the determination of the route are based on the scheduled appointment. The appointment-capable store can be determined to be one of the plurality of stores.

In some embodiments, a request can be received from the user for an appointment at an appointment-capable store, the request indicating a time of the appointment, and the appointment for the indicated time can be scheduled with the appointment-capable store. The determination of the plurality of stores and the determination of the route can be based on the scheduled appointment, the appointment-capable store being determined to be one of the plurality of stores.

In some embodiments, a time of a meeting is determined, a location of the meeting is determined, a corresponding mobile device for each of a plurality of members of the meeting is determined, and a notification for the meeting is provided on each corresponding mobile device of the members of the meeting. In some embodiments, a modification to at least one of the time of the meeting and the location of the meeting is determined, and the notification comprises an indication of the modification.

In some embodiments, the computing device comprises a mall computing device available for use by shoppers at the shopping mall other than the user, and the route is sent to a mobile device of the user. In some embodiments, the computing device comprises a mobile device of the user.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

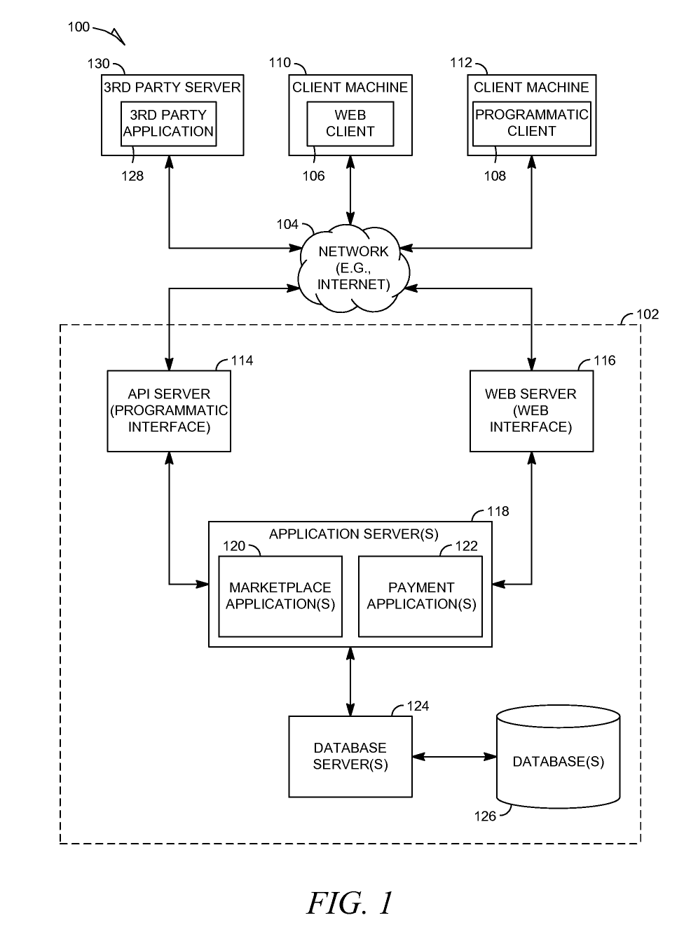

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by a third party. The third party website may, for example, provide one or more promotional, marketplace, or payment functions that are supported by the relevant applications of the networked system 102.

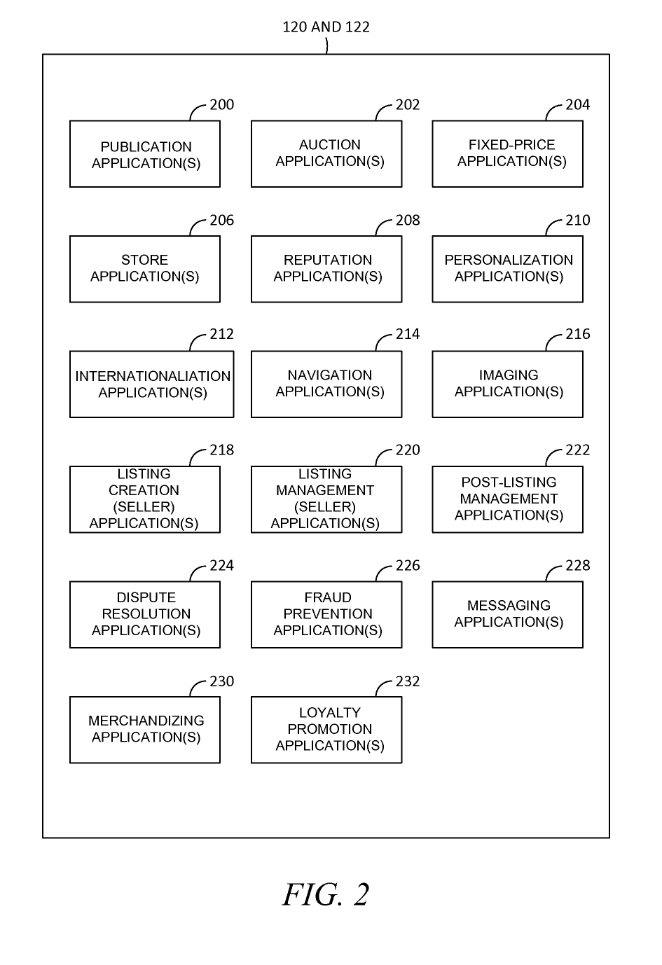

FIG. 2 is a block diagram illustrating multiple marketplace and payment applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may, furthermore, access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (e.g., through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example, a user may, utilizing an appropriate personalization application 210, create a personalized reference page on which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make the listings available via the networked system 102, as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or to providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

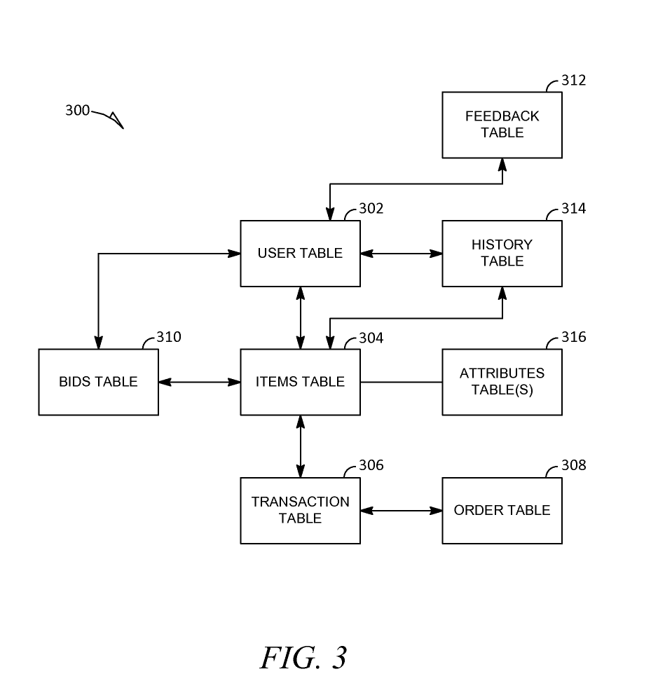

FIG. 3 is a high-level entity-relationship diagram, illustrating various tables 300 that may be maintained within the database(s) 126, and that are utilized by and support the applications 120 and 122. A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, each order record being associated with an order. Each order, in turn, may be with respect to one or more transactions for which records exist within the transaction table 306.

Bid records within a bids table 310 each relate to a bid received at the networked system 102 in connection with an auction-format listing supported by an auction application 202. A feedback table 312 is utilized by one or more reputation applications 208, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 may indicate a currency attribute associated with a particular item, the currency attribute identifying the currency of a price for the relevant item as specified by a seller.

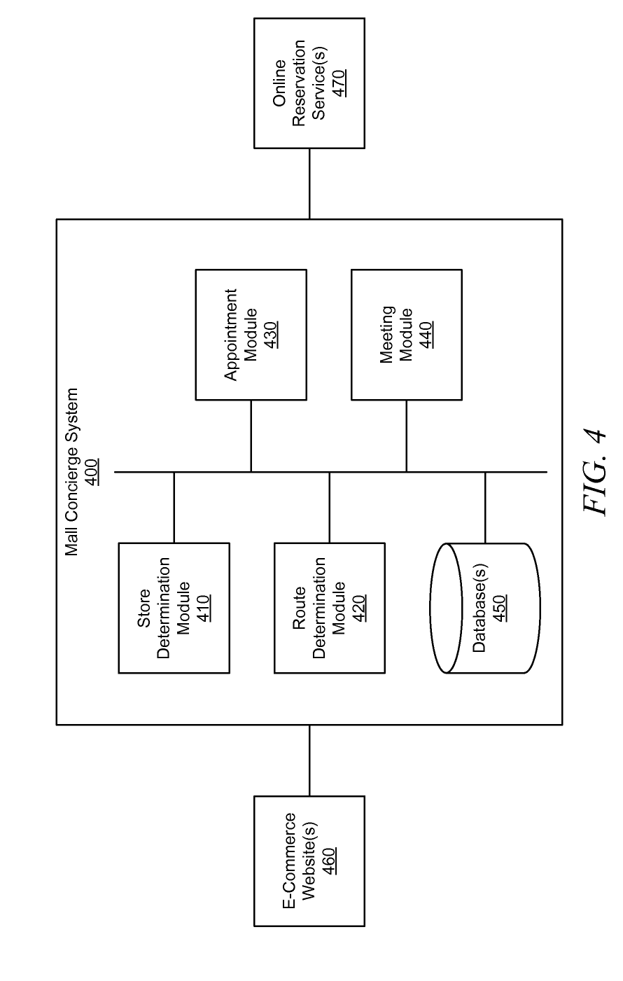

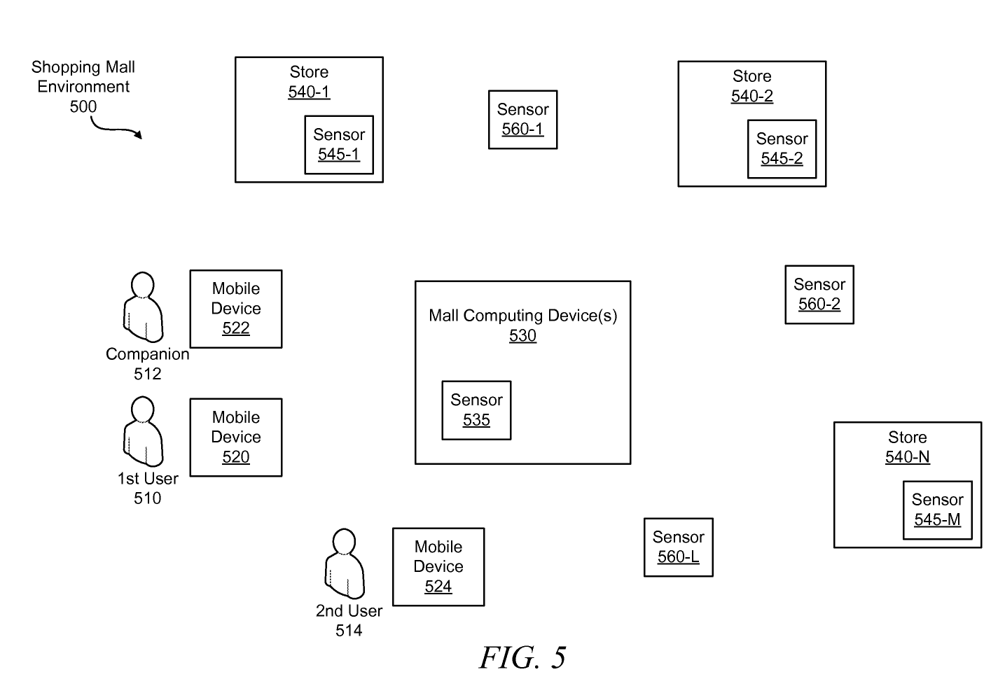

FIG. 4 is a block diagram illustrating a mall concierge system 400, in accordance with some embodiments. In some embodiments, mall concierge system 400 comprises a store determination module 410, a route determination module 420, an appointment module 430, and a meeting module 440. FIG. 5 illustrates a shopping mall environment 500 in which the mall concierge system 400 can be employed, in accordance with some embodiments.

In some embodiments, the modules 410, 420, 430, and 440 of the mall concierge system 400, as well as any other components of the mall concierge system 400, can reside on or be implemented by one or more mall computing devices 530. Mall computing device(s) 530 can comprise any computing device that is owned, operated, controlled, or otherwise associated with a physical shopping mall, and that is available for use by the general public at the shopping mall, as opposed to a user's mobile device that is only available for use by the owner of the mobile device and those people that the owner allows to use it. For example, a mall computing device can comprise a mall directory or kiosk located at a shopping mall.

In some embodiments, the modules 410, 420, 430, and 440 of the mall concierge system 400, as well as any other components of the mall concierge system 400, can reside on or be implemented by one or more mobile devices (e.g., smartphones, tablet computers, etc.). For example, the modules 410, 420, 430, and 440 of the mall concierge system 400, as well as any other components of the mall concierge system 400, can be implemented as part of a mobile application residing on a mobile device 520 of a first user 510, a mobile device 522 of a companion 512 of the first user 510, and/or on a mobile device 524 of a second user 514.

In some embodiments, the modules 410, 420, 430, and 440 of the mall concierge system 400, as well as any other components of the mall concierge system 400, can reside on or be implemented by one or more websites or online services. In some embodiments, the mall concierge system 400 can be incorporated into the application server(s) 118 in FIG. 1.

In some embodiments, a portion of the modules 410, 420, 430, and 440 of the mall concierge system 400, as well as any other components of the mall concierge system 400, can reside on or be implemented by one or more mall computing devices 530, and/or a portion can reside on or be implemented by one or more mobile devices 520, 522, 524, and/or a portion can reside on or be implemented by one or more websites or online services. For example, in some embodiments, features of the mall concierge system 400 can initially be provided on a mall computing device 530, and then features of the mall concierge system 400 (e.g., a determined route) can be sent (e.g., pushed) to a mobile device 520 of a first user 510, thereby enabling the first user 510 to use the features of the mall concierge system 400 after the first user 510 has walked away from and can no longer view the mall computing device 530.

The devices, systems, modules, databases, websites, and online services disclosed herein can communicate with other devices, systems, modules, databases, websites, and online services in a variety of ways. In some embodiments, any of these communications, such as any communications disclosed either explicitly or implicitly in reference to FIGS. 4-13, can be achieved via one or more networks. Examples of networks that can be used include, but are not limited to, a wired network, a wireless network (e.g., a mobile or cellular network), or any suitable combination thereof. The network(s) can include one or more portions that constitute a private network, a public network (e.g., the Internet), or any suitable combination thereof. Other configurations are also within the scope of the present disclosure.

The shopping mall environment 500 shown in FIG. 5 can include a plurality of stores 540-1 to 540-N. A shopping mall can comprise a large building or group of buildings containing many different stores, and can have interconnecting walkways enabling visitors to walk from store to store. The term “store” is used herein to refer to an entity having an assigned physical location at the shopping mall and offering a product or a service to users of the shopping mall. Examples of a “store” include, but are not limited to, clothing stores, electronics stores, department stores, beauty salons, and restaurants. The stores 540-1 to 540-N can be located inside a physical structure of the shopping mall or outside of the physical structure of the shopping mall, and can include traditional storefronts integrated into the physical structure of the shopping mall, as well as mall kiosks or retail merchandizing units, so long as they are considered part of the shopping mall. Temporary providers of products or services, such as temporary seasonal sections (e.g., an area designated for meeting Santa Claus), can also be considered stores within the scope of the present disclosure. In some embodiments, the stores can also include exhibits, vendors, booths, stalls, and stands.

In some embodiments, the store determination module 410 is configured to determine one or more of the plurality of stores 540-1 to 540-N for a first user 510 to visit at a shopping mall based on at least one experience preference indicator. The experience preference indicator can comprise any indication of a user preference for his or her experience at the shopping mall. Examples of experience preference indicators include, but are not limited to, a store identification (e.g., Macy's®), a store category (e.g., women's clothing, beauty salon, restaurant), a product identification (e.g., PlayStation® 4), a brand identification (e.g., Sony®), a product category (e.g., women's shoes), and a service category (e.g., hair cut). Other types of experience preference indicators are also within the scope of the present disclosure.

In some embodiments, the store determination module 410 is configured to determine the experience preference indicator(s) explicitly by prompting the first user 510 to submit at least one experience preference indicator, and then to receive the experience preference indicator(s) from the user. For example, the store determination module 410 can cause a user interface to be displayed that enables the first user 510 to select any of the previously discussed experience preference indicators (e.g., by touching a display screen on which the experience preference indicators are displayed) and/or that enables the first user 510 to type in any of the previously discussed experience preference indicators.

In some embodiments, the store determination module 410 is configured to determine the experience preference indicator(s) implicitly by determining an identification of the first user 510, accessing profile information of the first user 510 based on the identification of the first user 510, and determining the experience preference indicator(s) based on the accessed profile information. In some embodiments, the profile information comprises at least one of a history of stores the first user 510 has visited, a history of products the first user 510 has purchased, and a history of services the first user 510 has purchased. This historical profile information can be obtained from a variety of different source and can relate to the user's activity with respect to stores other than those in the physical shopping mall the user is currently visiting. For example, the historical profile information can also comprise information related to the user's activity at other stores, at other physical shopping malls, and at online stores (e.g., Amazon.com® and eBay.com®) and other websites (e.g., search engines). Information regarding a user's activity (e.g., purchases, visits, queries, etc.) can be retrieved in a variety of ways, including, but not limited to, reporting of such activities by websites, online services, sensors in physical stores (e.g., store sensors 545-1 to 545-N), sensors in physical shopping malls (e.g., walkway sensors 560-1 to 560-N), employees of physical stores, and store accounting systems. The profile information can also comprise the age of the first user 510, the gender of the first user 510, an address of the first user 510, a profession of the first user 510, an income of the first user 510, and other personal information of the first user 510.

Profile information of other users who are determined to be similar to the first user 510 can be used to determine the plurality of stores for the first user 510. The store determination module 410 can be configured to determine one or more users that are similar to the first user 510 based on their corresponding profile information meeting a predetermined threshold level of similarity. For example, the store determination module 410 can determine that the second user 514 is similar to the first user 510 based on a determination that the age of the second user 514 is within 5 years of the age of the first user 510 and that the second user 514 and the first user 510 are both of the same gender. In another example, the store determination module 410 can determine that the second user 514 is similar to the first user 510 based on a determination that the second user 514 has visited at least 5 of the same stores as the first user 510 within a predetermined period of time (e.g., within the last 3 months). Based on a determined similarity between the first user 510 and the second user 514, the store determination module 410 can determine to recommend that the first user 510 visit one or more stores visited by the second user 514.

Profile information of a user can be stored in and/or retrieved from one or more databases 450. Although FIG. 4 shows database(s) 450 residing within the mall concierge system 400, it is contemplated that the profile information can be retrieved from third party sources owned, operated, and controlled by separate entities from that of the mall concierge system 400, such as one or more e-commerce websites 460 or other online services.

In some embodiments, the determination of the plurality of stores can also be based on context information. The context information can comprise at least one of a time of day for the first user 510 visiting the plurality of stores (e.g., 2:34 pm), a day of the week for the first user 510 visiting the plurality of stores (e.g., Monday), at least one scheduled appointment for the first user 510, at least one crowd level data corresponding to the first user 510 visiting the plurality of stores, an amount of time the first user 510 wants his or her shopping experience to last (e.g., 2 hours), a number of companions 512 of the first user 510 (e.g., 1 companion), a type of companion 512 of the first user 510 (e.g., husband or child), and a promotion being offered by at least one of the plurality of stores (e.g., 50% reduced prices for men's shirts).

In some embodiments, the scheduled appointment(s) can be scheduled via the appointment module 430, as will be discussed in further detail below. In some embodiments, the scheduled appointment(s) can be scheduled independently of the appointment module 430, and the corresponding information (e.g., time, date, duration, store, location, etc.) for the scheduled appointment(s) can be retrieved from a calendar application associated with the first user 510 (e.g., a calendar application on the mobile device 520 of the first user 510).

In some embodiments, the crowd level(s) comprise at least one of corresponding crowd levels for each one of the plurality of stores and corresponding crowd levels for different walking paths between the plurality of stores. In some embodiments, the corresponding crowd levels for each one of the plurality of stores and corresponding crowd levels for different walking paths between the plurality of stores can be determined based on at least one of current crowd levels and previous crowd levels. In some embodiments involving current crowd levels, the crowd levels can be retrieved subsequent to the first user 510 initiating the current interaction with the mall concierge system 400 or within a predetermined amount of time preceding the first user 510 initiating the current interaction with the mall concierge system 400 (e.g., within 15 minutes from the time the first user 510 initiated the current interaction). In some embodiments involving previous crowd levels, a predictive model can be applied to historical information of previous crowd levels to predict what the crowd levels will be during the first user's experience of visiting the plurality of stores.

Crowd level data can be determined in a variety of ways. In some embodiments, one or more store sensors 545-1 to 545-M for the stores 540-1-540-N and/or one or more walkway sensors 560-1 to 560-L for the walkways between the stores 540-1 to 540-N can be used to determine crowd levels. A variety of different sensors (or people counters) can be used, including, but not limited to, infrared beams, computer vision, thermal imaging, pressure-sensitive sensors (e.g., mats), audio sensors, and image capture devices. The sensors can detect, estimate, or otherwise determine crowd level indications, including, but not limited to, current body density in stores, length of lines for dressing rooms at stores, length of lines for checkout at stores, and body density in the interconnecting walkways between the stores.

In some embodiments, the type of companion 512 can influence the determination of the store(s) by the store determination module 410. For example, if a mother is visiting the shopping mall with her two children, the store determination module 410 can determine that visiting a store that sells children's clothing is appropriate for this visit, while visiting a lingerie shop is not appropriate for this visit, and thus select the store that sells children clothing, while omitting the lingerie shop.

The store determination module 410 can determine the number and type of companions 512, as well as the identity of the first user 510, in a variety of ways. In some embodiments, this information can be provided explicitly by the first user 510 via one or more user interface elements on the mall computing device 530 and/or on the mobile device 520 of the first user 510. In some embodiments, this information can be determined implicitly by the mall concierge system 400 using one or more sensors 535 of the mall computing device 530 (or on the mobile device(s) of the first user 510 and/or the companion(s) 512). For example, the mall computing device 530 can employ one or more image capture devices and computer vision techniques to determine the number of companions 512 the first user 510, such as by identifying any person within a predetermined distance of the first user 510 as a companion 512 of the first user 510, but disregarding other users (e.g., the second user 514) who are not within the predetermined distance of the first user 510 as not being a companion 512 of the first user 510. The mall computing device 530 can also employ one or more image capture devices and computer vision techniques to determine a classification of the companion(s) 512 based on detected information about gender, height, age, and clothing.

In some embodiments, the route determination module 420 is configured to determine a route for the first user 510 to use in visiting the plurality of stores. The determination can be based on at least one crowd level corresponding to visiting the plurality of stores. In some embodiments, the crowd level(s) comprise at least one of corresponding crowd levels for each one of the plurality of stores and corresponding crowd levels for different walking paths between the plurality of stores. In some embodiments, the corresponding crowd levels for each one of the plurality of stores and corresponding crowd levels for different walking paths between the plurality of stores are determined based on at least one of current crowd levels and a predictive model using historical information of previous crowd levels, as previously discussed. In some embodiments, the determination of the route is based on context information, such as the context information previously discussed.

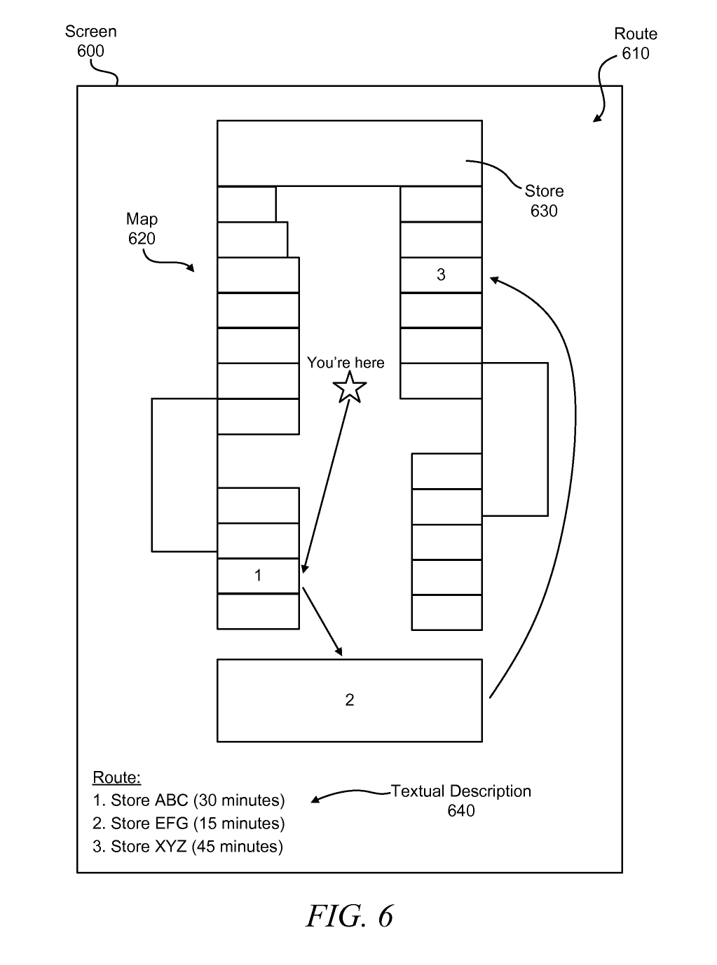

The route can be caused to be displayed to the first user 510 on a computing device, such as the mall computing device 530 and/or the mobile device 520 of the first user 510. In some embodiments, the route is caused to be displayed as part of a map displayed to the user. FIG. 6 illustrates a route 610 being displayed on a screen 600 of a computing device (e.g., mall computing device 530, mobile device 520), in accordance with some embodiments. The route 610 can be displayed as part of a map 620 of stores 630 in the shopping mall environment 500. The stores determined by the store determination module 410 for visiting by the first user 510 can be labeled with indicators (e.g., 1, 2, 3, etc.) to indicate their determination as stores to be visited, as well as to indicate the order in which they should be visited. In some embodiments, the route 610 can include arrows (straight or curved) to indicate the path of the route 610. Additionally, a textual description 640 of the route 610 can be provided, indicating the names of the stores to be visited, the order in which they are to be visited, and the amount of time that the first user 510 is expected to stay at each store (e.g., 30 minutes at Store ABC, 15 minutes at Store EFG, and 45 minutes at Store XYZ).

In some embodiments, the mall concierge system 400 can modify the stores to be visited and/or the route to be used by the first user 510 in response to and based on update information received by the mall concierge system 400. This update information can include, but is not limited to, newly determined crowd levels (e.g., a change in current or predicted crowd levels since the route determination was initially made), a change in the first user's schedule according to the first user's calendar application, and a change in a scheduled event of a store or the shopping mall.

In some embodiments, the appointment module 430 is configured to determine a recommendation for an appointment for a user at an appointment-capable store. An appointment-capable store can be any store of the shopping mall capable of accepting an appointment (e.g., restaurants, salons, etc.). The recommendation for the appointment can be determined based on any combination of one or more of the user inputs, experience preference indicators, and context information previously discussed.

In some embodiments, the appointment module 430 is configured to cause the recommendation for the appointment to be displayed to the first user 510 on a computing device (e.g., mall computing device 530 and/or mobile device 520). The recommendation for the appointment can comprise an identification of a store at which the appointment is to be made and a time for which the appointment is to be made. The appointment module 430 can then receive a request for the appointment from the first user 510. The request can comprise an approval confirmation of the recommendation or a modification of the recommendation (e.g., the user can request the appointment at the same store for a different time than originally recommended). The request can indicate a time of the appointment. The appointment module 430 can then schedule the appointment for the indicated time with the appointment-capable store. In some embodiments, the previously-discussed determination of the plurality of stores and the determination of the route can be based on or influenced by the scheduled appointment. The appointment-capable store can be determined to be one of the plurality of stores for the first user 510 to visit.

In some embodiments, the appointment module 430 can be configured to receive a request from the first user 510 for an appointment at an appointment-capable store without determining and providing a recommendation for an appointment. The request can indicate a time of the appointment. The appointment module 430 can then schedule the appointment for the indicated time with the appointment-capable store. The previously-discussed determination of the plurality of stores and the determination of the route can be based on the scheduled appointment. The appointment-capable store can be determined to be one of the plurality of stores for the first user 510 to visit.

In some embodiments, the appointment module 430 can be configured to schedule an appointment with an appointment-capable store via an appointment or reservation service of the appointment-capable store. In some embodiments, the appointment module 430 can be configured to schedule an appointment with an appointment-capable store via one or more online reservation services 470 (e.g., OpenTable®). The appointment module 430 can be configured to modify a calendar application on the mobile device 520 of the first user 510 and/or the mobile device(s) 522 of the companion(s) 512 of the first user 510 to reflect the scheduled appointment.

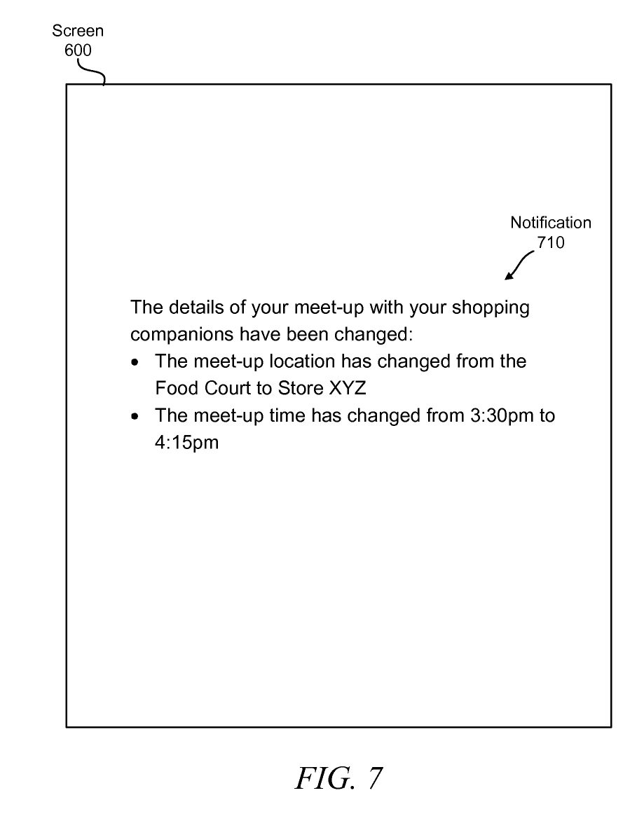

In some embodiments, the meeting module 440 is configured to enable users to establish a time and location at which a user and his or her companions can meet during their experience at the shopping mall. The meeting module 440 is configured to enable the users and companions to separate, make adjustments to the details of the meeting (e.g., time and/or location), and be notified of adjustments to the details of the meeting. In some embodiments, the meeting module 440 is configured to determine a time of a meeting, a location of the meeting, and a corresponding mobile device for each of a plurality of members of the meeting. The time, location, and corresponding mobile device(s) can be determined based on user input provided by the first user 510 explicitly providing each piece of information. The meeting module 440 can be configured to provide a notification for the meeting on each corresponding mobile device of the members of the meeting. In some embodiments, a modification to at least one of the time of the meeting and the location of the meeting is determined, and a notification comprising an indication of the modification can be provided to any users and companions associated with the meeting. FIG. 7 illustrates a notification 710 being displayed on a screen 600 of a mobile device, in accordance with some embodiments.

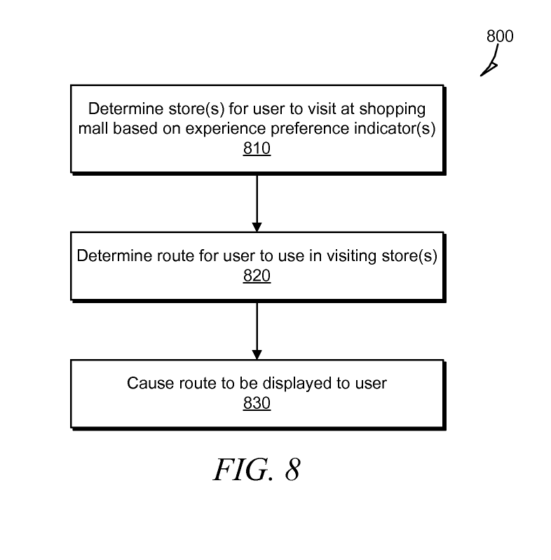

FIG. 8 is a flowchart illustrating a method 800, in accordance with some embodiments. The operations of method 800 may be performed by a system or modules of a system (e.g., mall concierge system 400 in FIG. 4). At operation 810, a plurality of stores for a user to visit at a shopping mall can be determined based on at least one experience preference indicator, as previously discussed herein. At operation 820, a route for the user to use in visiting the plurality of stores can be determined based on at least one crowd level corresponding to visiting the plurality of stores, as previously discussed herein. At operation 830, the route can be caused to be displayed to the user on a computing device, as previously discussed herein. It is contemplated that the operations of method 800 may incorporate any of the other features disclosed herein.

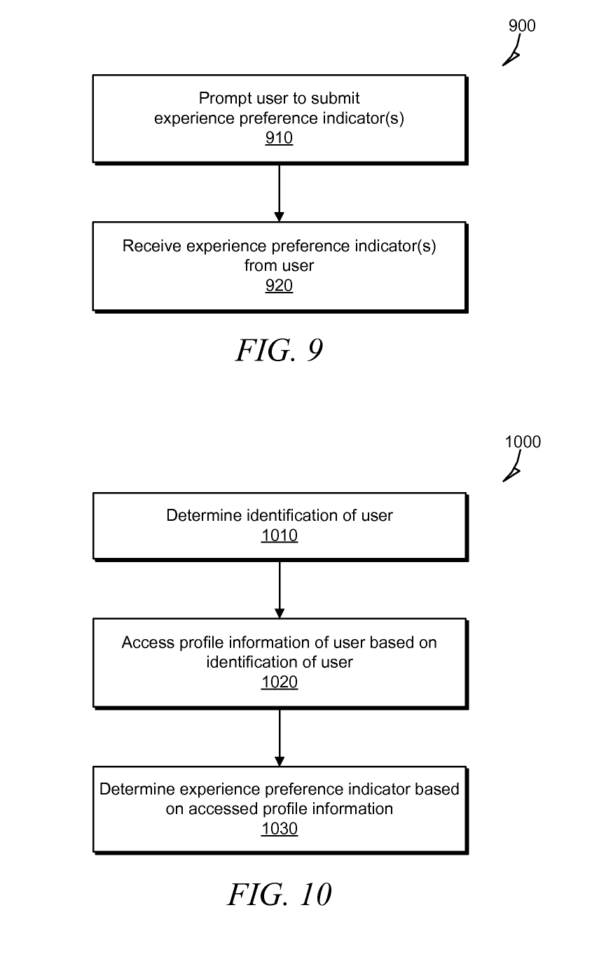

FIG. 9 is a flowchart illustrating a method 900, in accordance with some embodiments. The operations of method 900 may be performed by a system or modules of a system (e.g., mall concierge system 400 in FIG. 4). In some embodiments, the operations of method 900 can be performed as part of determining the plurality of stores at operation 810 of FIG. 8. At operation 910, the user can be prompted to submit the at least one experience preference indicator, as previously discussed herein. At operation 920, the at least one experience preference indicator can be received from the user, as previously discussed herein. It is contemplated that the operations of method 900 may incorporate any of the other features disclosed herein.

FIG. 10 is a flowchart illustrating a method 1000, in accordance with some embodiments. The operations of method 1000 may be performed by a system or modules of a system (e.g., mall concierge system 400 in FIG. 4). In some embodiments, the operations of method 1000 can be performed as part of determining the plurality of stores at operation 810 of FIG. 8. At operation 1010, an identification of the user can be determined, as previously discussed herein. At operation 1020, profile information of the user can be accessed based on the identification of the user, as previously discussed herein. At operation 1030, the at least one experience preference indicator can be determined based on the accessed profile information, as previously discussed herein. It is contemplated that the operations of method 1000 may incorporate any of the other features disclosed herein.

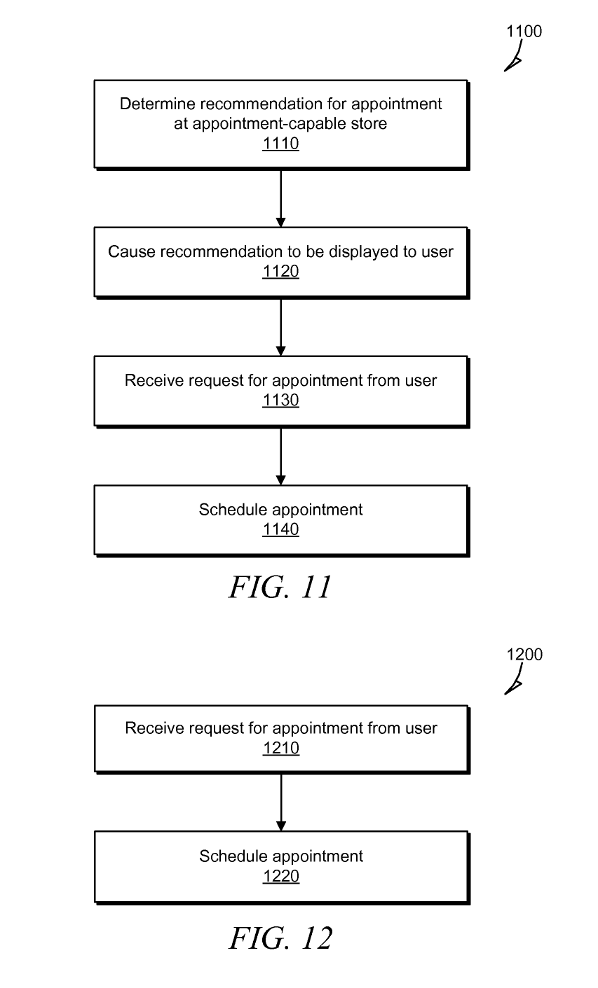

FIG. 11 is a flowchart illustrating a method 1100, in accordance with some embodiments. The operations of method 1100 may be performed by a system or modules of a system (e.g., mall concierge system 400 in FIG. 4). In some embodiments, the operations of method 1100 can be performed in combination with the operations of FIG. 8. At operation 1110, a recommendation for an appointment for a user at an appointment-capable store can be determined, as previously discussed herein. At operation 1120, the recommendation for the appointment can be caused to be displayed to the user on the computing device, as previously discussed herein. At operation 1130, a request for the appointment can be received from the user, as previously discussed herein. The request can indicate a time of the appointment. At operation 1140, the appointment for the indicated time can be scheduled with the appointment-capable store, as previously discussed herein. It is contemplated that the operations of method 1100 may incorporate any of the other features disclosed herein.

FIG. 12 is a flowchart illustrating a method 1200, in accordance with some embodiments. The operations of method 1200 may be performed by a system or modules of a system (e.g., mall concierge system 400 in FIG. 4). In some embodiments, the operations of method 1200 can be performed in combination with the operations of FIG. 8. At operation 1210, a request can be received from the user for an appointment at an appointment-capable store, as previously discussed herein. The request can indicate a time of the appointment. At operation 1220, the appointment for the indicated time can be scheduled with the appointment-capable store, as previously discussed herein. It is contemplated that the operations of method 1200 may incorporate any of the other features disclosed herein.

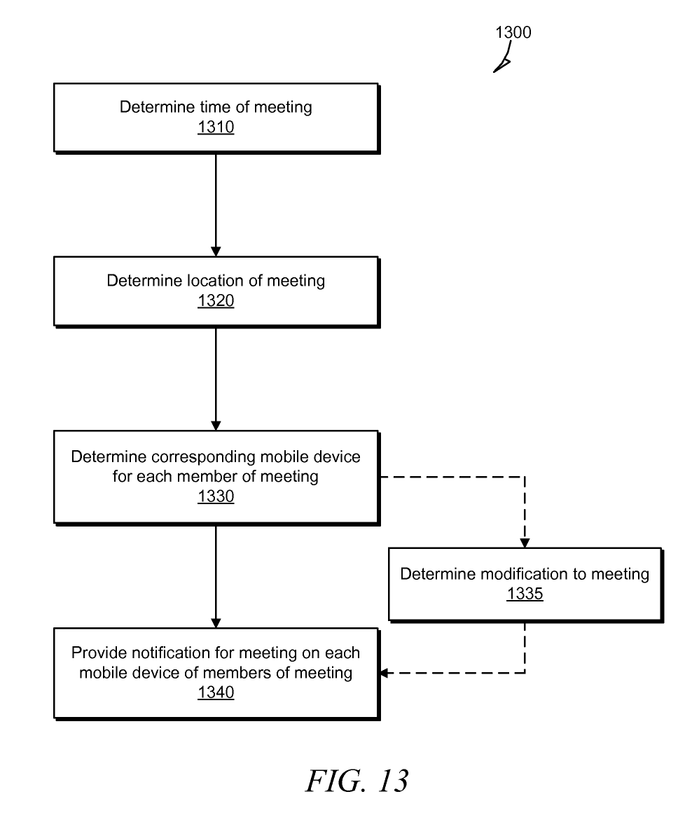

FIG. 13 is a flowchart illustrating a method 1300, in accordance with some embodiments. The operations of method 1300 may be performed by a system or modules of a system (e.g., mall concierge system 400 in FIG. 4). In some embodiments, the operations of method 1300 can be performed in combination with the operations of FIG. 8. At operation 1310, a time of a meeting can be determined, as previously discussed herein. At operation 1320, a location of the meeting can be determined, as previously discussed herein. At operation 1330, a corresponding mobile device for each of a plurality of members of the meeting can be determined, as previously discussed herein. At operation 1340, a notification for the meeting can be provided on each corresponding mobile device of the members of the meeting, as previously discussed herein. In some embodiments, subsequent to the details of the meeting and the corresponding mobile devices for each member of the meeting being determined at operations 1310, 1320, and 1330, a modification to at least one of the time of the meeting and the location of the meeting can be determined at operation 1335, as previously discussed herein. The notification provided at operation 1340 can comprise an indication of the modification, as previously discussed herein. It is contemplated that the operations of method 1300 may incorporate any of the other features disclosed herein.

It is contemplated that any features of any embodiments disclosed herein can be combined with any other features of any other embodiments disclosed herein. Accordingly, any such hybrid embodiments are within the scope of the present disclosure.

### Example Mobile Device

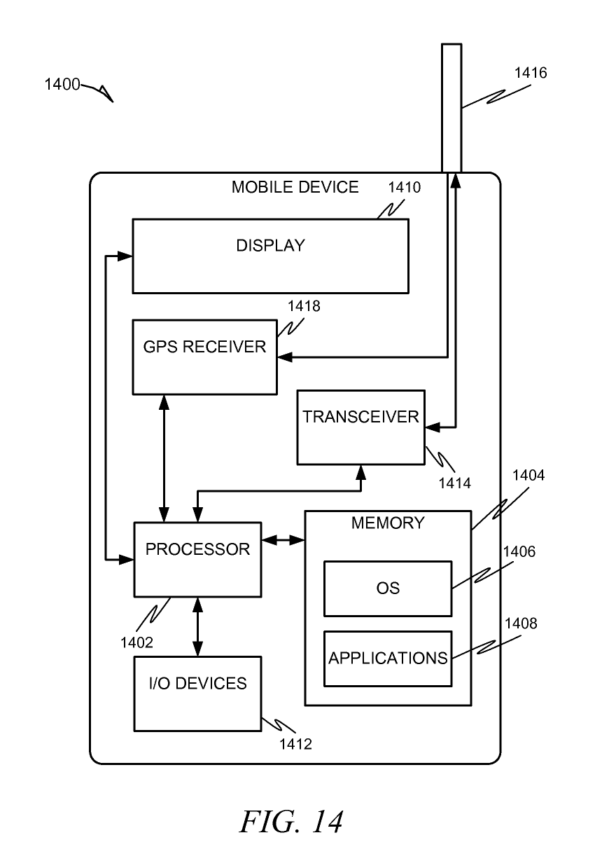

FIG. 14 is a block diagram illustrating a mobile device 1400, according to an example embodiment. The mobile device 1400 can include a processor 1402. The processor 1402 can be any of a variety of different types of commercially available processors suitable for mobile devices 1400 (for example, an XScale architecture microprocessor, a Microprocessor without Interlocked Pipeline Stages (MIPS) architecture processor, or another type of processor). A memory 1404, such as a random access memory (RAM), a Flash memory, or other type of memory, is typically accessible to the processor 1402. The memory 1404 can be adapted to store an operating system (OS) 1406, as well as application programs 1408, such as a mobile location enabled application that can provide location-based services (LBSs) to a user. The processor 1402 can be coupled, either directly or via appropriate intermediary hardware, to a display 1410 and to one or more input/output (I/O) devices 1412, such as a keypad, a touch panel sensor, a microphone, and the like. Similarly, in some embodiments, the processor 1402 can be coupled to a transceiver 1414 that interfaces with an antenna 1416. The transceiver 1414 can be configured to both transmit and receive cellular network signals, wireless data signals, or other types of signals via the antenna 1416, depending on the nature of the mobile device 1400. Further, in some configurations, a GPS receiver 1418 can also make use of the antenna 1416 to receive GPS signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

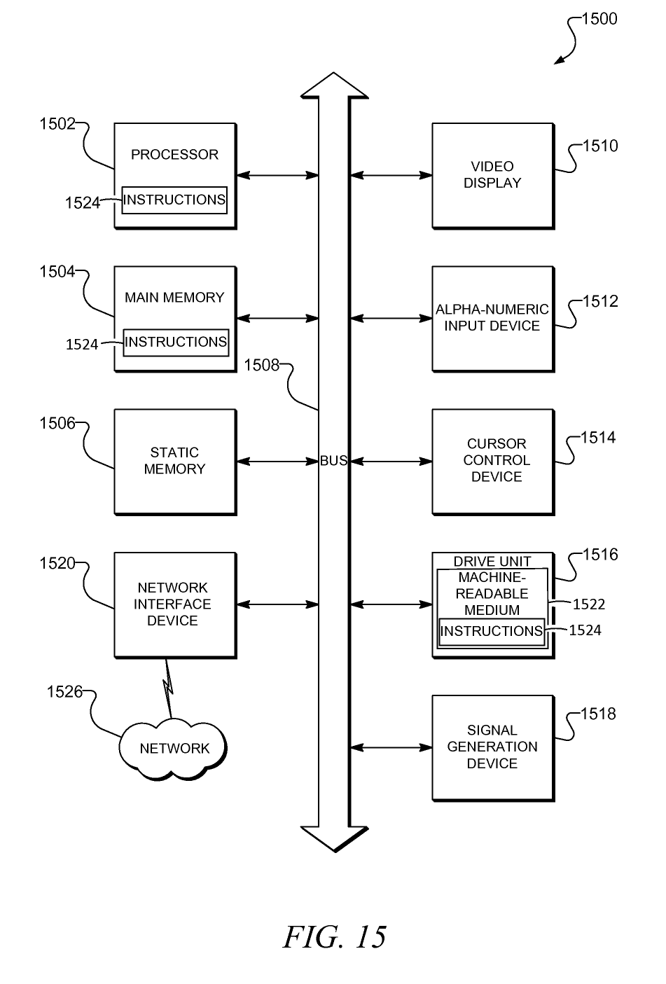

FIG. 15 is a block diagram of a machine in the example form of a computer system 1500 within which instructions 1524 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1504 and a static memory 1506, which communicate with each other via a bus 1508. The computer system 1500 may further include a video display unit 1510 (e.g., a liquid crystal display (LCD) or a cathode ray tube (CRT)). The computer system 1500 also includes an alphanumeric input device 1512 (e.g., a keyboard), a user interface (UI) navigation (or cursor control) device 1514 (e.g., a mouse), a disk drive unit 1516, a signal generation device 1518 (e.g., a speaker) and a network interface device 1520.

### Machine-Readable Medium

The disk drive unit 1516 includes a machine-readable medium 1522 on which is stored one or more sets of data structures and instructions 1524 (e.g., software) embodying or utilized by any one or more of the methodologies or functions described herein. The instructions 1524 may also reside, completely or at least partially, within the main memory 1504 and/or within the processor 1502 during execution thereof by the computer system 1500, the main memory 1504 and the processor 1502 also constituting machine-readable media. The instructions 1524 may also reside, completely or at least partially, within the static memory 1506.

While the machine-readable medium 1522 is shown in an example embodiment to be a single medium, the term “machine-readable medium” may include a single medium or multiple media (e.g., a centralized or distributed database, and/or associated caches and servers) that store the one or more instructions 1524 or data structures. The term “machine-readable medium” shall also be taken to include any tangible medium that is capable of storing, encoding, or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1524 may further be transmitted or received over a communications network 1526 using a transmission medium. The instructions 1524 may be transmitted using the network interface device 1520 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
determining a plurality of stores for a user to visit at a shopping mall based on at least one experience preference indicator, the at least one experience preference indicator indicating an experience preference associated with the user;
determining, by a machine having a memory and at least one processor, a route for the user to use in visiting the plurality of stores based on crowd level data, the crowd level data indicating at least one crowd level associated with visiting the plurality of stores; and
causing the route to be displayed to the user on a computing device.

2. The method of claim 1, wherein the route is caused to be displayed as part of a map displayed to the user.

3. The method of claim 1, wherein the at least one crowd level comprises at least one of corresponding crowd levels for each one of the plurality of stores and corresponding crowd levels for different walking paths between the plurality of stores.

4. The method of claim 3, wherein the corresponding crowd levels for each one of the plurality of stores and corresponding crowd levels for different walking paths between the plurality of stores are determined based on at least one of current crowd levels and a predictive model using historical information of previous crowd levels.

5. The method of claim 1, wherein the determining of the plurality of stores comprises:
prompting the user to submit the at least one experience preference indicator; and
receiving the at least one experience preference indicator from the user.

6. The method of claim 1, wherein the at least one experience preference indicator comprises at least one of a store identification, a store category, a product identification, a brand identification, a product category, and a service category.

7. The method of claim 1, wherein the determining of the plurality of stores comprises:
determining an identification of the user;
accessing profile information of the user based on the identification of the user; and
determining the at least one experience preference indicator based on the accessed profile information.

8. The method of claim 7, wherein the profile information comprises at least one of a history of stores the user has visited, a history of products the user has purchased, and a history of services the user has purchased.

9. The method of claim 1, wherein the determination of the plurality of stores is further based on context information, the context information comprising at least one of a time of day for the user visiting the plurality of stores, a day of the week for the user visiting the plurality of stores, an amount of desired or available shopping time, at least one scheduled appointment for the user, a crowd level corresponding to the user visiting the plurality of stores, a number of companions of the user, a type of companion of the user, and a promotion being offered by at least one of the plurality of stores.

10. The method of claim 1, wherein the determination of the route is based on context information, the context information comprising at least one of a time of day for the user visiting the plurality of stores, a day of the week for the user visiting the plurality of stores, at least one scheduled appointment for the user, a crowd level corresponding to the user visiting the plurality of stores, a number of companions of the user, a type of companion of the user, and a promotion being offered by at least one of the plurality of stores.

11. The method of claim 1, further comprising:
determining a recommendation for an appointment for the user at an appointment-capable store;
causing the recommendation for the appointment to be displayed to the user on the computing device;
receiving a request for the appointment from the user, the request indicating a time of the appointment; and
scheduling the appointment for the indicated time with the appointment-capable store.

12. The method of claim 11, wherein the determination of the plurality of stores and the determination of the route are based on the scheduled appointment, the appointment-capable store being determined to be one of the plurality of stores.

13. The method of claim 1, further comprising:
receiving a request from the user for an appointment at an appointment-capable store, the request indicating a time of the appointment; and
scheduling the appointment for the indicated time with the appointment-capable store,
wherein the determination of the plurality of stores and the determination of the route are based on the scheduled appointment, the appointment-capable store being determined to be one of the plurality of stores.

14. The method of claim 1, further comprising:
determining a time of a meeting;
determining a location of the meeting;
determining a corresponding mobile device for each of a plurality of members of the meeting; and
providing a notification for the meeting on each corresponding mobile device of the members of the meeting.

15. The method of claim 14, further comprising determining a modification to at least one of the time of the meeting and the location of the meeting, wherein the notification comprises an indication of the modification.

16. The method of claim 1, wherein the computing device comprises a mall computing device available for use by shoppers at the shopping mall other than the user, and the method further comprises sending the route to a mobile device of the user.

17. The method of claim 1, wherein the computing device comprises a mobile device of the user.

18. A system comprising:
a machine having a memory and at least one processor; and
at least one module, executable by the at least one processor, configured to:
determine a plurality of stores for a user to visit at a shopping mall based on at least one experience preference indicator;
determine a route for the user to use in visiting the plurality of stores based on crowd level data, the crowd level data indicating at least one crowd level associated with visiting the plurality of stores; and
cause the route to be displayed to the user on a computing device.

19. The system of claim 18, wherein the at least one module is further configured to:
receive a request from the user for an appointment at an appointment-capable store, the request indicating a time of the appointment; and
schedule the appointment for the indicated time with the appointment-capable store,
wherein the determination of the plurality of stores and the determination of the route are based on the scheduled appointment, the appointment-capable store being determined to be one of the plurality of stores.

20. A non-transitory machine-readable storage medium storing a set of instructions that, when executed by at least one processor, causes the at least one processor to perform a set of operations comprising:
determining a plurality of stores for a user to visit at a shopping mall based on at least one experience preference indicator;
determining a route for the user to use in visiting the plurality of stores based crowd level data, the crowd level data indicating at least one crowd level associated with visiting the plurality of stores; and
causing the route to be displayed to the user on a computing device.
